(19) United States
(12) Patent Application Publication
(10) Pub. No.: US 2026/0221657 A1
(43) Pub. Date: Jul. 30, 2026

(54) ULTRA-BROADBAND DUAL-POLARIZED FOLDED DIPOLE

(71) Applicant: HUAWEI TECHNOLOGIES CO., LTD., Shenzhen (CN)

(72) Inventors: Ignacio Gonzalez, Munich (DE); Bruno Biscontini, Munich (DE)

(73) Assignee: HUAWEI TECHNOLOGIES CO., LTD., Shenzhen (CN)

(21) Appl. No.: 19/573,326

(22) Filed: Mar. 20, 2026

Related U.S. Application Data
(63) Continuation of application No. PCT/EP2023/076080, filed on Sep. 21, 2023.

(51) Int. Cl. H01Q 9/27; H01Q 19/10

(52) U.S. Cl. CPC H01Q 9/27; H01Q 19/108

(57) ABSTRACT

The present disclosure relates to dipole antennas, for example, to antenna array radiating elements in an Active Antenna System (AAS). A radiating element of this disclosure comprises a substrate and at least two dipole arms formed on the substrate. In this regard, each dipole arm comprises at least two current paths with different electrical length. Furthermore, at least one outer area up to the edge of the substrate is bent. Moreover, at least one current path of the at least two current paths extends to the bent outer area of the substrate.

### CROSS-REFERENCE TO RELATED APPLICATIONS

This application is a continuation of International Application No. PCT/EP2023/076080, filed on Sep. 21, 2023, the disclosure of which is hereby incorporated by reference in its entirety.

### FIELD

The present disclosure relates to dipole antennas, for example, to antenna array radiating elements in an Active Antenna System (AAS), where the radio transceiver unit is integrated with base station antenna systems.

### BACKGROUND

Generally, array antennas used in mobile communication networks may comprise several radiators that mostly comprise relatively complex metallic, i.e., generally conductive, structures. These radiators may be realized using different production technologies, such as die casted, sheet metal radiators in combination with additional plastic parts, etched planar radiators with several planar substrates and additional plastic parts, or injection molded plastic parts with metalized structures on it. However, in order to produce a 3D antenna shape, a molding-based process may be required, which can be costly and may impose certain design constraints.

### SUMMARY

In view of the above, this disclosure aims to provide an improved radiating element and a fabrication method thereof. For example to achieve a 3D antenna shape with a very large bandwidth in a very limited space.

The foregoing and further implementations may be achieved by the features of the independent claims, dependent claims, the description, and the drawings.

According to a first aspect of this disclosure, a radiating element is provided. The radiating element comprises a substrate and at least two dipole arms formed on the substrate. In this regard, each dipole arm comprises at least two current paths with different electrical length. Furthermore, at least one outer area up to the edge of the substrate is bent. Moreover, at least one current path of the at least two current paths extends to the bent outer area of the substrate.

Accordingly, this disclosure presents an alternative to generate 3D structures for the antenna array radiating elements. The radiating elements can be produced in a planar fashion and can be processed afterwards to generate the 3D structure, in particular, by having the one or more bent outer areas of the substrate. This may realize one or more bent sides of the substrate. In this regard, the outer area of the substrate may be understood as the region of the dipole extending at least slightly away from the feeding point to the edge of the substrate.

The radiating element of the first aspect may advantageously enable antenna miniaturization and the additional degree of freedom of the 3D structure can be exploited to increase the operating frequency range of existing bands, e.g., in modern base station antenna systems, in particular, by means of the additional current paths.

In an implementation form of the first aspect, at least one of the at least two current paths is configured to support modes that radiate at least one first frequency of a first frequency range. Additionally, at least one of the at least two current paths is configured to support modes that radiate at least one second frequency of a second frequency range.

In an implementation form of the first aspect, the first frequency is lower than the second frequency. Additionally, the first frequency range and the second frequency range are separate from each other or partly overlap.

For example, the highest frequency of the first frequency range may be lower than the lowest frequency of the second frequency range. Additionally or alternatively, the center frequency of the first frequency range may be lower than the center frequency of the second frequency range. Additionally or alternatively, the first frequency range may be different from the second frequency range. Alternatively, the first frequency range and the second frequency range may in-part overlap.

Advantageously, for instance, the different propagating modes of the current paths may extend the impedance bandwidth supported by the bent or folded substrate.

In an implementation form of the first aspect, the substrate is a flexible substrate.

In an implementation form of the first aspect, the flexible substrate is a foil substrate.

This may allow for a design that requires fewer parts, e.g., compared to a wrapped counterpart realized in different technologies, lower weight, and lower cost.

In an implementation form of the first aspect, the at least one bent outer area of the substrate is bent into a spiral shape.

This may enable more electrical paths, e.g., compared to a planar structure, without increasing the overlapping radiating area more than necessary. Furthermore, folding, e.g., by rolling, in the spiral shape may help to avoid current cancellation from opposite directions as sections of the dipole arms are not parallel.

In an implementation form of the first aspect, the radiating element comprises a support member configured to maintain the spiral shape.

In an implementation form of the first aspect, the support member comprises one or more pin spacers.

This may allow for a uniform spacing between the overlapping areas, i.e., a more constant distance to the ground plane along the different current paths, while firmly maintaining the spiral shape.

In an implementation form of the first aspect, the radiating element comprises a plurality of feeding points, each corresponds to a pair of dipole arms, and a feeder operably coupled to the plurality of feeding points, the feeder being configured to supply orthogonal feeds to the plurality of feeding points.

This may facilitate dual-orthogonal polarization of the radiating element, which can be fed, e.g., with a PCB, in a conventional manner.

In an implementation form of the first aspect, at least two outer areas up to the edge of the substrate are bent, and at least one current path extends to each of the at least two bent outer areas of the substrate.

In an implementation form of the first aspect, the at least two bent outer areas comprise two opposite edges of the substrate. Alternatively, the at least two bent outer areas comprise two adjacent edges of the substrate.

In an implementation form of the first aspect, the at least two bent outer areas of the substrate are bent in the same direction. Alternatively, the at least two bent outer areas of the substrate are bent in opposite directions.

This may allow for an effective reduction in the overall footprint of the radiating element.

In an implementation form of the first aspect, an outer area up to each edge of the substrate is bent, and at least one current path extends to each bent outer area of the substrate.

In an implementation form of the first aspect, each bent outer area of the substrate is bent in the same direction. Alternatively, two adjacent bent outer areas of the substrate are bent in opposite directions.

This may allow for a further reduction in the overall footprint of the radiating element.

According to a second aspect of this disclosure, a dual-polarized antenna is provided. The dual-polarized antenna comprises a reflector and one or more radiating elements according to the first aspect of this disclosure. In this regard, each of the one or more radiating elements is arranged on the reflector at a predefined distance to the reflector.

According to a third aspect of this disclosure, a method is provided for forming a radiating element. The method comprises the steps of providing a substrate, forming at least two dipole arms on the substrate such that each dipole arm comprises at least two current paths with different electrical length, and bending at least one outer area up to the edge of the substrate, wherein at least one current path of the at least two current paths extends to the bent outer area of the substrate.

It is to be noted that the dual-polarized antenna according to the second aspect and the method according to the third aspect correspond to the radiating element according to the first aspect and its implementation forms. Further, the dual-polarized antenna of the second aspect and the method of the third aspect achieve the same advantages and effects as the radiating element of the first aspect and its respective implementation forms.

### BRIEF DESCRIPTION OF THE DRAWINGS

The above described aspects and implementation forms will be explained in the following description of exemplary embodiments in relation to the enclosed drawings, in which:

FIG. 1 shows an exemplary diagram of a square dipole according to this disclosure;

FIG. 2A shows exemplary current paths of the unfolded dipole;

FIG. 2B shows the effect of folding of the dipole of FIG. 2A;

FIG. 3A shows a first exemplary folding arrangement of the dipole;

FIG. 3B shows a second exemplary folding arrangement of the dipole;

FIG. 3C shows a third exemplary folding arrangement of the dipole;

FIG. 3D shows a fourth exemplary folding arrangement of the dipole;

FIG. 3E shows a fifth exemplary folding arrangement of the dipole;

FIG. 4 shows the folding arrangement of the dipole in relation to the antenna plane;

FIG. 5 shows a dual-polarized antenna according to this disclosure; and

FIG. 6 shows an exemplary flow diagram of the method according to this disclosure.

### DETAILED DESCRIPTION

Reference will now be made in detail to exemplary embodiments of the present disclosure, which are illustrated in the accompanying drawings. However, the following embodiments of the present disclosure may be variously modified and the range of the disclosure is not limited by the following embodiments. Reference signs for similar entities in different embodiments are partially omitted.

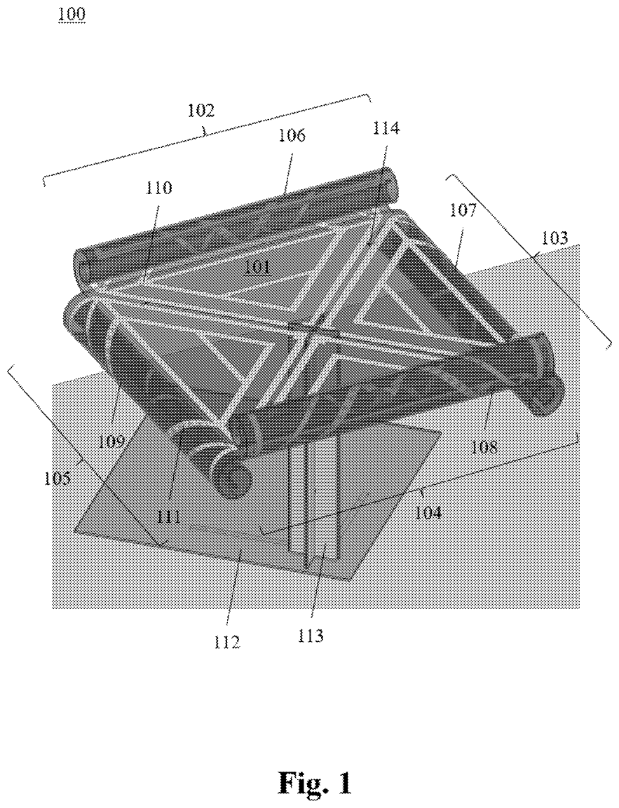

In FIG. 1, an exemplary diagram of a square dipole 100 according to the first aspect of this disclosure is illustrated. The square dipole 100 may comprise a substrate 101 and four dipole arms 102, 103, 104, 105 formed on the substrate 101. For example, the dipole arms 102, 103, 104, 105 may be formed by forming or printing current paths 110, 111 of different electrical lengths on the substrate 101 corresponding to each of the dipole arms 102, 103, 104, 105.

For example, the substrate 101 may be a flexible substrate or a foil, and the outer area 106, 107, 108, 109 up to the edge of the substrate 101, i.e., the edges of the substrate 101, corresponding to the dipole arms 102, 103, 104, 105 may be folded or bent in a spiral shape. The current paths 110, 111 of different electrical lengths may be formed on the substrate 101 such that the current paths 110, 111 may extend to the bent outer areas or bent edges 106, 107, 108, 109. In other words, the substrate 101 may be produced in a planar fashion and may be folded or bent in a posterior process.

For instance, among the current paths 110, 111, the electrically long paths may support modes that may radiate at the lower frequencies and the electrically shorter paths may support modes that may radiate at higher frequencies. As such, the operating range of the square dipole 100 may be determined by the difference in electrical length of the supported modes. In this regard, the dipole arms 102, 103, 104, 105 may be realized by folding or bending the outer areas 106, 107, 108, 109 of the substrate 101 corresponding to the dipole arms 102, 103, 104, 105 such that different current paths projections may not overlap.

The square dipole 100 may further comprise feeding points 114 corresponding to a pair of dipole arms 102, 103, 104, 105, and a feeder 113 coupled to the feeding points 114. The feeder or the feeder structure 113 may be formed on a printed circuit board (PCB) 112. The feeder 113 may supply orthogonal feeds to the feeding points 114.

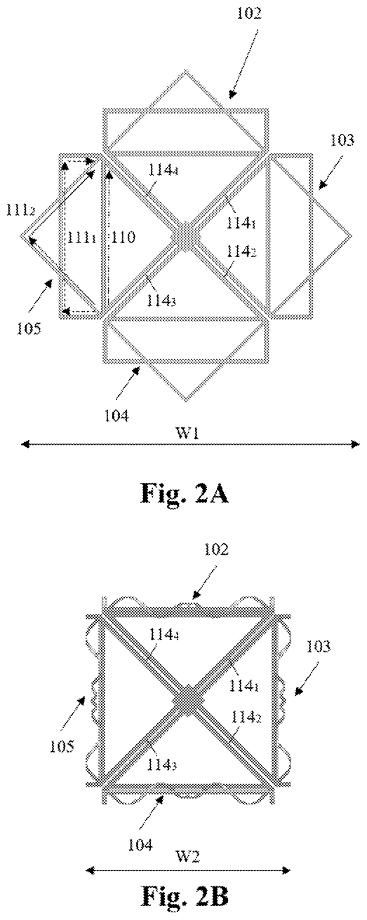

In FIG. 2A, exemplary current paths 110, 111 of the unfolded dipole are illustrated. In this example, the current paths 110, 111 for the dipole arm 105, i.e., in the unfolded outer area 109, are illustrated. For instance, the feeding point 1141 may correspond to the pair of dipole arms 102 and 103, the feeding point 1142 may correspond to the pair of dipole arms 103 and 104, the feeding point 1143 may correspond to the pair of dipole arms 104 and 105, and the feeding point 1144 may correspond to the pair of dipole arms 105 and 102.

For example, the current paths 110, 1111, and 1112 may be extended to the outer area 109 of the substrate 101 corresponding to the dipole arm 105. In this example, the current path 110 may have a shorter electrical length compared to the current paths 1111 and 1112. Furthermore, the current path 1111 may have a shorter electrical length compared to the current path 1112. Accordingly, the current paths 110, 1111, and 1112 may support different propagating modes, thereby extending the operating bandwidth of the square dipole 100. For example, the unfolded dipole may have a width W1 of 223 mm.

In FIG. 2B, the effect of folding of the dipole of FIG. 2A is illustrated. For example, the folding effect can be achieved by folding or bending the outer areas 106, 107, 108, 109 of the substrate 101 corresponding to the dipole arms 102, 103, 104, 105. Furthermore, the folding process may be performed by rolling the outer areas 106, 107, 108, 109 of the substrate 101 in spiral such that the sections of the dipole arms 102, 103, 104, 105 may not be parallel, which may help to avoid current cancellation from opposite direction.

Moreover, the folding process may be performed by rolling the outer areas 106, 107, 108, 109 of the substrate 101 in spiral such that the longer current paths corresponding to the dipole arms 102, 103, 104, 105 may be arranged further from the ground plane, e.g., to maintain a more constant distance to the ground plane along the different current paths. For example, the folded dipole may have a width W2 of 132 mm, i.e., a size reduction of 40% can be achieved compared to the unfolded dipole of FIG. 2A, while retaining the extended operating bandwidth.

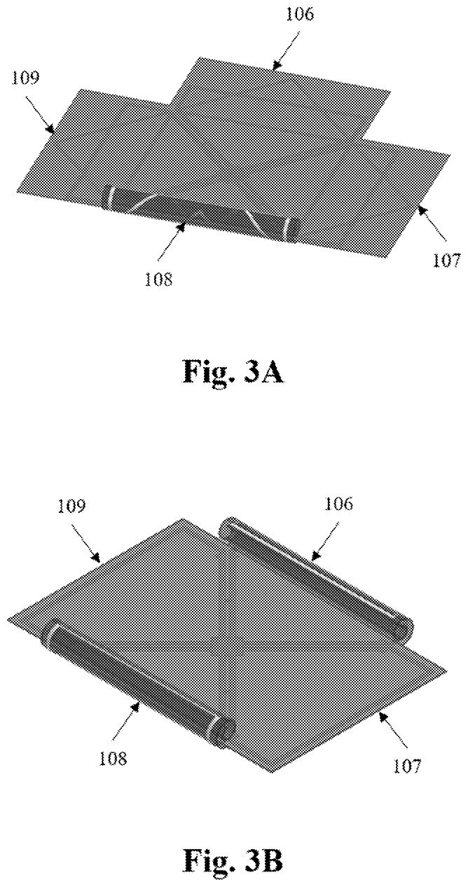

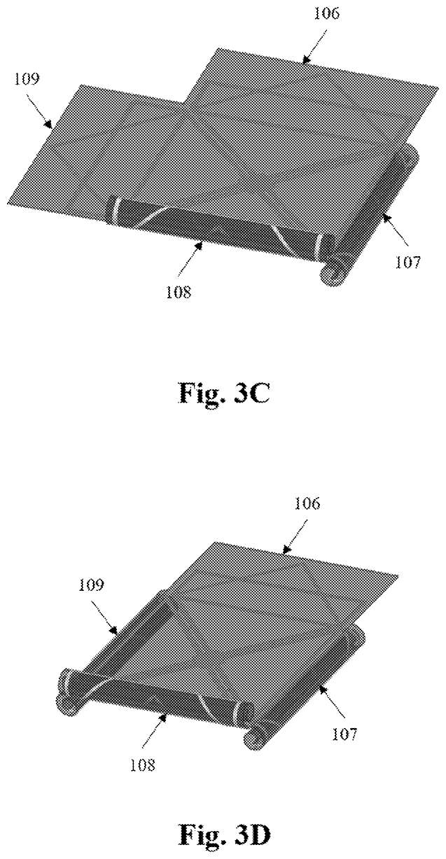

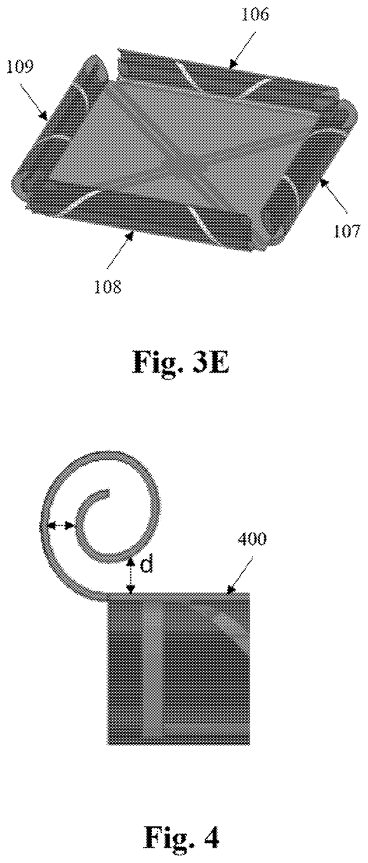

In FIG. 3A, a first exemplary folding arrangement of the square dipole 100 is illustrated. The first outer area 106 of the substrate 101 may correspond to the first dipole arm 102 of the square dipole 100, the second outer area 107 of the substrate 101 may correspond to the second dipole arm 103 of the square dipole 100, the third outer area 108 of the substrate 101 may correspond to the third dipole arm 104 of the square dipole 100, and the fourth outer area 109 of the substrate 101 may correspond to the fourth dipole arm 105 of the square dipole 100.

The current paths 110, 111 may be formed on the substrate 101 such that the current paths 110, 111 may extend to the outer areas 106, 107, 108, 109 of the substrate 101. In this example, the third outer area 108 of the substrate 101 may be folded in spiral in the upward direction. Although not shown, the third outer area 108 of the substrate 101 may be folded in spiral in the downward direction.

In FIG. 3B, a second exemplary folding arrangement of the square dipole 100 is illustrated. The first outer area 106 of the substrate 101 may correspond to the first dipole arm 102 of the square dipole 100, the second outer area 107 of the substrate 101 may correspond to the second dipole arm 103 of the square dipole 100, the third outer area 108 of the substrate 101 may correspond to the third dipole arm 104 of the square dipole 100, and the fourth outer area 109 of the substrate 101 may correspond to the fourth dipole arm 105 of the square dipole 100.

The current paths 110, 111 may be formed on the substrate 101 such that the current paths 110, 111 may extend to the outer areas 106, 107, 108, 109 of the substrate 101. In this example, the first outer area 106 of the substrate 101 and the third outer area 108 of the substrate 101 may be folded in spiral in the upward direction.

Although not shown, the first outer area 106 of the substrate 101 and the third outer area 108 of the substrate 101 may be folded in spiral in the downward direction. Furthermore, the first outer area 106 of the substrate 101 may be folded in spiral in the upward direction and the third outer area 108 of the substrate 101 may be folded in spiral in the downward direction, or vice versa.

In FIG. 3C, a third exemplary folding arrangement of the square dipole 100 is illustrated. The first outer area 106 of the substrate 101 may correspond to the first dipole arm 102 of the square dipole 100, the second outer area 107 of the substrate 101 may correspond to the second dipole arm 103 of the square dipole 100, the third outer area 108 of the substrate 101 may correspond to the third dipole arm 104 of the square dipole 100, and the fourth outer area 109 of the substrate 101 may correspond to the fourth dipole arm 105 of the square dipole 100.

The current paths 110, 111 may be formed on the substrate 101 such that the current paths 110, 111 may extend to the outer areas 106, 107, 108, 109 of the substrate 101. In this example, the second outer area 107 of the substrate 101 may be folded in spiral in the downward direction, and the third outer area 108 of the substrate 101 may be folded in spiral in the upward direction.

Although not shown, the second outer area 107 of the substrate 101 may be folded in spiral in the upward direction, and the third outer area 108 of the substrate 101 may be folded in spiral in the downward direction. Furthermore, both the second outer area 107 of the substrate 101 and the third outer area 108 of the substrate 101 may be folded in spiral in the upward direction or in the downward direction.

In FIG. 3D, a fourth exemplary folding arrangement of the square dipole 100 is illustrated. The first outer area 106 of the substrate 101 may correspond to the first dipole arm 102 of the square dipole 100, the second outer area 107 of the substrate 101 may correspond to the second dipole arm 103 of the square dipole 100, the third outer area 108 of the substrate 101 may correspond to the third dipole arm 104 of the square dipole 100, and the fourth outer area 109 of the substrate 101 may correspond to the fourth dipole arm 105 of the square dipole 100.

The current paths 110, 111 may be formed on the substrate 101 such that the current paths 110, 111 may extend to the outer areas 106, 107, 108, 109 of the substrate 101. In this example, the second outer area 107 of the substrate 101 may be folded in spiral in the downward direction, the third outer area 108 of the substrate 101 may be folded in spiral in the upward direction, and the fourth outer area 109 of the substrate 101 may be folded in spiral in the downward direction.

Although not shown, the second outer area 107 of the substrate 101 may be folded in spiral in the upward direction, the third outer area 108 of the substrate 101 may be folded in spiral in the downward direction, and the fourth outer area 109 of the substrate 101 may be folded in spiral in the upward direction. Furthermore, each of the second outer area 107 of the substrate 101, the third outer area 108 of the substrate 101, and the fourth outer area 109 of the substrate 101 may be folded in spiral in the upward direction or in the downward direction.

In FIG. 3E, a fifth exemplary folding arrangement of the square dipole 100 is illustrated. The first outer area 106 of the substrate 101 may correspond to the first dipole arm 102 of the square dipole 100, the second outer area 107 of the substrate 101 may correspond to the second dipole arm 103 of the square dipole 100, the third outer area 108 of the substrate 101 may correspond to the third dipole arm 104 of the square dipole 100, and the fourth outer area 109 of the substrate 101 may correspond to the fourth dipole arm 105 of the square dipole 100.

The current paths 110, 111 may be formed on the substrate 101 such that the current paths 110, 111 may extend to the outer areas 106, 107, 108, 109 of the substrate 101. In this example, each of the first outer area 106 of the substrate 101, the second outer area 107 of the substrate 101, the third outer area 108 of the substrate 101, and the fourth outer area 109 of the substrate 101 may be folded in spiral in the upward direction.

Although not shown, each of the first outer area 106 of the substrate 101, the second outer area 107 of the substrate 101, the third outer area 108 of the substrate 101, and the fourth outer area 109 of the substrate 101 may be folded in spiral in the downward direction. Furthermore, the first outer area 106 of the substrate 101 and the third outer area 108 of the substrate 101 may be folded in spiral in the upward direction and the second outer area 107 of the substrate 101 and the fourth outer area 109 of the substrate 101 may be folded in spiral in the downward direction, or vice versa.

In FIG. 4, the folding arrangement of the dipole in relation to the antenna plane 400 is illustrated. For example, two consecutive folded dipole arms are illustrated, which may be folded in spiral in opposite directions with respect to the antenna plane 400. The folded spiral structure may comprise a constant spiral spacing d, e.g., to maintain the lambda relationship. The folded spiral structure may be maintained via one or more supports, e.g., plastic supports or pin spacers, placed on the sides of the folded spiral structure.

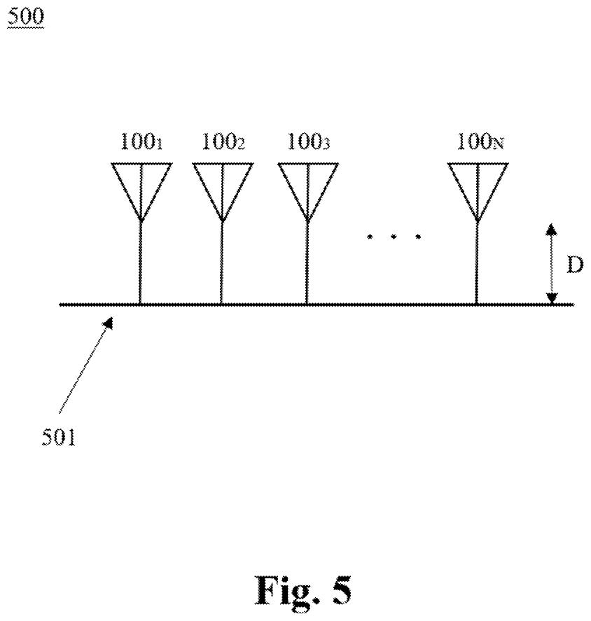

In FIG. 5, a dual-polarized antenna 500 according to the second aspect of this disclosure is illustrated. The antenna 500 may comprise a reflector 501 and a number of N square dipoles 1001-100N arranged on the reflector 501, where N≥1. The number of N square dipoles 1001-100N may be arranged on the reflector 501 at a predefined distance D to the reflector 501. For instance, the antenna 500 may be a mobile communication antenna and the number of N square dipoles 1001-100N may act as the radiating elements of the mobile communication antenna.

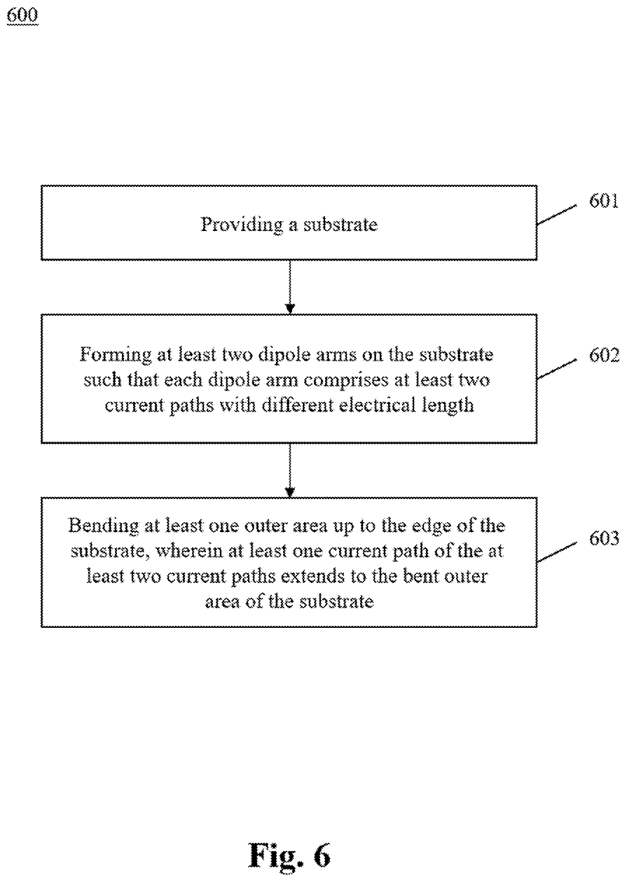

In FIG. 6, an exemplary embodiment of the method 600 according to the third aspect of this disclosure is illustrated. In a first step 601, a substrate is provided. In a second step 602, at least two dipole arms are formed on the substrate such that each dipole arm comprises at least two current paths with different electrical length. In a third step 603, at least one outer area up to the edge of the substrate is bent, where at least one current path of the at least two current paths extends to the bent outer area of the substrate.

It is important to note that, in the description as well as in the claims, the word “comprising” does not exclude other elements or steps and the indefinite article “a” or “an” does not exclude a plurality. A single element or other unit may fulfill the functions of several entities or items recited in the claims. Furthermore, the word “coupled” implies that the elements may be directly connected together or may be coupled through one or more intervening elements. Moreover, the disclosure with regard to any of the aspects is also relevant with regard to the other aspects of the disclosure.

Although the disclosure has been illustrated and described with respect to one or more implementations, equivalent alterations and modifications will occur to others skilled in the art upon the reading and understanding of this specification and the annexed drawings. In addition, while a particular feature of this disclosure may have been disclosed with respect to only one of several implementations, such feature may be combined with one or more other features of the other implementations as may be desired and advantageous for any given or particular application.

What is claimed is:

1. A radiating element comprising:
a substrate, and
at least two dipole arms formed on the substrate,
wherein each dipole arm comprises at least two current paths with different electrical length,
wherein at least one outer area up to the edge of the substrate is bent, and
wherein at least one current path of the at least two current paths extends to the bent outer area of the substrate.

2. The radiating element according to claim 1, wherein:
at least one of the at least two current paths is configured to support modes that radiate at least one first frequency of a first frequency range, and
at least one of the at least two current paths is configured to support modes that radiate at least one second frequency of a second frequency range.

3. The radiating element according to claim 2, wherein:
the first frequency is lower than the second frequency, and
the first frequency range and the second frequency range are separate from each other or partly overlap.

4. The radiating element according to claim 1, wherein the substrate is a flexible substrate.

5. The radiating element according to claim 4, wherein the flexible substrate is a foil substrate.

6. The radiating element according to claim 1, wherein the at least one bent outer area of the substrate is bent into a spiral shape.

7. The radiating element according to claim 6, further comprising a support member configured to maintain the spiral shape.

8. The radiating element according to claim 7, wherein the support member comprises one or more pin spacers.

9. The radiating element according to claim 1, further comprising:
a plurality of feeding points, each corresponds to a pair of dipole arms, and
a feeder operably coupled to the plurality of feeding points, the feeder being configured to supply orthogonal feeds to the plurality of feeding points.

10. The radiating element according to claim 1, wherein at least two outer areas up to the edge of the substrate are bent, and at least one current path extends to each of the at least two bent outer areas of the substrate.

11. The radiating element according to claim 10, wherein:
the at least two bent outer areas comprise two opposite edges of the substrate, or
the at least two bent outer areas comprise two adjacent edges of the substrate.

12. The radiating element according to claim 10, wherein:
the at least two bent outer areas of the substrate are bent in the same direction, or
the at least two bent outer areas of the substrate are bent in opposite directions.

13. The radiating element according to claim 1, wherein an outer area up to each edge of the substrate is bent, and at least one current path extends to each bent outer area of the substrate.

14. The radiating element according to claim 13, wherein:
each bent outer area of the substrate is bent in the same direction, or
two adjacent bent outer areas of the substrate are bent in opposite directions.

15. A dual polarized antenna comprising:
a reflector, and
one or more radiating elements,
wherein the one or more radiating elements comprise a substrate, and at least two dipole arms formed on the substrate, wherein each dipole arm comprises at least two current paths with different electrical length, wherein at least one outer area up to the edge of the substrate is bent, and wherein at least one current path of the at least two current paths extends to the bent outer area of the substrate,
wherein each of the one or more radiating elements is arranged on the reflector at a predefined distance to the reflector.

16. A method for forming a radiating module, comprising:
providing a substrate,
forming at least two dipole arms on the substrate such that each dipole arm comprises at least two current paths with different electrical length, and
bending at least one outer area up to the edge of the substrate, wherein at least one current path of the at least two current paths extends to the bent outer area of the substrate.
